(19) United States
(12) Patent Application Publication
(10) Pub. No.: US 2026/0235168 A1
(43) Pub. Date: Aug. 13, 2026

(54) JOINT INNER PART AND ARRANGEMENT COMPRISING A GRIPPING MEANS AND A JOINT INNER PART

(71) Applicant: GKN Driveline International GmbH, Lohmar (DE)

(72) Inventors: Orkan Eryilmaz, Lohmar (DE); Charles Rowley, Lohmar (DE); Nicolas Seguin, Lohmar (DE)

(21) Appl. No.: 19/537,107

(22) Filed: Feb. 11, 2026

(30) Foreign Application Priority Data
Feb. 12, 2025 (DE) 102025105219.0

(51) Int. Cl. F16D 3/40

(52) U.S. Cl. CPC F16D 3/40

(57) ABSTRACT

A joint inner part of a multipod joint has a rotation axis, a central body extending along the rotation axis between a first end face and a second end face, and at least two trunnions. The trunnions are distributed along a circumferential direction extending around the rotation axis, and each extends from the central body along a trunnion axis and at least along a radial direction extending perpendicular to the rotation axis and to the circumferential direction. At least one recess is arranged on one end face of the central body, which recess extends from the end face to an outer circumferential surface of the central body. The recess has a contact area which forms a bearing area effective relative to the circumferential direction.

### CROSS REFERENCE TO RELATED APPLICATIONS

This application claims the priority to German Patent Application No. DE 102025105219.0 filed on Feb. 12, 2025, and the content of this priority application is incorporated herein by reference in its entirety.

### technical field

The disclosure relates to a joint inner part and an arrangement comprising a gripping means and a joint inner part. The joint inner part is an inner part of a multipod joint, preferably a tripod joint. The gripping means serves to clamp the joint inner part in a machining device for machining the trunnion surfaces.

### BACKGROUND

A multi-or tripod joint is generally known. A multi-or tripod joint is a special design of a plunging constant velocity joint. It comprises an outer part with a rotation axis and an inner part with a rotation axis, wherein the inner part has at least two trunnions (two trunnions: bipod joint, three trunnions: tripod joint). The trunnions are arranged evenly distributed along a circumferential direction extending around the respective rotation axis.

The outer part has a cavity for the inner part extending along the rotation axis of the outer part, as well as a number of raceways corresponding to the number of trunnions, the raceways extending along this rotation axis and being distributed along a circumferential direction. The inner part has a central body extending along the rotation axis of the inner part and a corresponding number of trunnions, each having a trunnion axis, the trunnions being distributed along a circumferential direction and each extending from the central body at least along a radial direction. A roller body is arranged on each trunnion, which contacts the trunnion with an inner circumferential surface and the respective raceway with an outer circumferential surface.

The inner part is displaceable relative to the outer part along the first rotation axis, whereby the roller bodies roll in the respective raceway during the displacement.

The multipod joint described here is a so-called GI joint. In a GI joint, the roller body is formed by a ring body (which forms the outer circumferential surface), which is mounted directly on the trunnion via rolling elements (which form the inner circumferential surface). The roller body can also be mounted directly on the trunnion, in which case the ring body forms both the outer circumferential surface and the inner circumferential surface, i.e., no rolling elements are provided in this case.

In particular, the outer circumferential surface extends coaxially to a roller body axis, whereby the roller body axis and the respective trunnion axis can be tilted relative to each other by an angle of no more than three degrees. In particular, the trunnion or its circumferential surface, against which the roller body rests, is essentially cylindrical, in particular circularly cylindrical.

The joint inner part can be deflected relative to the joint outer part by a deflection angle. The deflection angle is the angle between the rotation axes. In a GI joint, the roller body is pivoted relative to the raceways or the joint outer part by the trunnion or the joint inner part.

Such joint inner parts are usually manufactured by forging. Forging is usually followed by mechanical processing. In particular, the cylindrical circumferential surfaces of the trunnions are mechanically processed, e.g., by a turning or grinding tool.

For mechanical machining, the joint inner part is held in a machining device by two clamping means. These contact the end faces of the joint inner part and form a force-fit connection relative to the circumferential direction. The clamping devices are arranged in particular coaxially with the rotation axis of the joint inner part. The machining device has a rotation axis that extends transversely to the clamping devices and thus transversely to the rotation axis of the joint inner part. The joint inner part is arranged between the clamping devices in such a way that one trunnion axis is arranged coaxially with the rotation axis. By rotating the joint inner part around the rotation axis, the circumferential surface of the respective trunnion can be machined mechanically. The other trunnions are machined after the clamping means have been rotated (indexed) (around their axis) and thus the joint inner part around its rotation axis.

WO 95/12767 A1 and WO 97/02438 A1 each describe tripod joints in which the trunnion axes are inclined relative to the radial direction. Mechanical machining of the trunnions is difficult, particularly in such joints, because the trunnion axes are not parallel to the end faces of the joint inner part.

The task of the present disclosure is to at least partially solve the problems mentioned in relation to the prior art. In particular, a joint inner part of a multipod joint is to be proposed, the manufacture of which can be carried out in a simple and reproducible manner.

### SUMMARY

A joint inner part with the features according to claim 1 contributes to solving these problems. Advantageous further developments are the subject of the dependent claims. The features listed individually in the claims can be combined with each other in a technologically meaningful way and can be supplemented by explanatory facts from the description and/or details from the figures, whereby further embodiments of the disclosure are shown.

A joint inner part of a multipod joint is proposed, wherein the joint inner part has a rotation axis, a central body extending along the rotation axis between a first end face and a second end face, and at least two trunnions, wherein the trunnions are distributed along a circumferential direction extending around the rotation axis and each extend from the central body along a trunnion axis and at least along a radial direction. The radial direction extends perpendicularly to the rotation axis and to the circumferential direction. At least one recess is arranged on (only) one end face of the central body, wherein the recess extends from the end face to an outer circumferential surface of the central body. The recess has a contact area which forms a bearing area effective in relation to the circumferential direction.

The joint inner part has, in particular, two trunnions (bipod joint), three trunnions (tripod joint) or more trunnions.

The joint inner part can be designed in a known manner. In contrast to known joint inner parts, however, at least one recess is arranged on at least one (or only exactly one) end face of the central body. This recess is not formed on an inner circumferential surface of the joint inner part (which is usually designed as a hub and then has a spline toothing on the inner circumferential surface), but only on the end face and the outer circumferential surface.

Compared to the usual shape of the central body, the recess forms a local indentation into which a gripping element of a gripping device can engage. The gripping device is arranged in a machining device, which is described in the introduction section, between one of the clamping devices and one end face of the joint inner part. The gripping device has a number of gripping elements corresponding to the number of recesses. Each gripping element forms a form-fitting connection with one recess with regard to the circumferential direction. This allows the joint inner part to be clamped securely.

The form-fitting connection acts in particular (only) in one of the circumferential directions (clockwise or counterclockwise), but can also act in both circumferential directions. The recess can be shaped in particular so that the form-fitting connection can only be formed in one circumferential direction.

In particular, the recess has a contact area that forms a bearing area for the gripping element that is effective in relation to the circumferential direction, i.e., the gripping element contacts the contact area and rests against the bearing area.

A contact area is the area of the recess that is basically arranged in such a way that a gripping element could contact it due to the geometry of the gripping element and the geometry of the recess when the gripping device is used in the machining device. In contrast, the bearing area is the area or the point or line contact that is/ which are actually contacted by the gripping element when the gripping device is used in the machining device.

In particular, at least one trunnion axis extends at an inclination angle relative to the radial direction and in a plane formed by the rotation axis and the radial direction, the absolute value of the inclination angle being greater than zero degrees.

In particular, all trunnion axes extend at the same inclination angle relative to the radial direction.

The inclination angle is determined in particular between the trunnion axis and the radial direction extending perpendicular to the rotation axis of the joint inner part. In particular, the inclination angle extends (exclusively) in a plane comprising the rotation axis of the joint inner part and the radial direction.

The absolute value of the inclination angle is in particular between 2 and 10 angular degrees, in particular between 3 and 9 angular degrees, preferably between 4 and 8 angular degrees. In particular, a slight deviation of the position of the trunnion axis from the aforementioned plane is possible, e.g., of at most five degrees, preferably of at most two degrees, particularly preferably of at most one degree.

Particularly with this inclination of the trunnion axis(es), mechanical processing of the trunnion surface in a machining device, e.g., by turning or grinding, is only possible with difficulty. Alignment of the joint inner part via the known clamping means and the end faces is now not possible because the trunnion axes do not run parallel to the end faces. The proposed at least one recess is particularly advantageous for such joint inner parts.

In particular, the at least one recess is arranged exclusively on the end face from which the trunnion axis, extending at the inclination angle, extends away.

In particular, at least three recesses, preferably exactly three or exactly six, are arranged (only) on one end face and distributed (evenly) along the circumferential direction. In particular, several pairs of recesses may also be provided. For example, two (identical) recesses may be provided twice, or three or four identical recesses may be provided twice.

In particular, a plurality of recesses are arranged (only) on one end face and (evenly) distributed along the circumferential direction, each recess being arranged along the circumferential direction between two trunnion axes which are arranged adjacent to each other along the circumferential direction. In particular, the recesses are arranged such that none of the recesses is aligned with a trunnion axis or extends to the trunnion axis or beyond the trunnion axis, when the joint inner part is viewed along the rotation axis.

In particular, the recess is designed such that it extends from the end face along the axis of rotation to such an extent that it intersects with the trunnion, in a view of the joint inner part from the side, i.e., in a view transverse to the rotation axis of the joint inner part. In this view, the projection of the trunnion and the recess onto the rotation axis is looked at.

In particular, the contact area is convex in shape. In particular, the contact area is convexly curved, in particular spherically curved.

The joint inner part is produced in particular by forging. In particular, the recesses are also produced in this process. In particular, no mechanical reworking of the recesses is necessary after forging. The workpiece falling from the forge may be damaged by contact with other workpieces or parts of the forge equipment. However, damage to these surfaces can be prevented or even ruled out as a result of the overall concave designed surfaces of the recesses which extend into the workpiece.

A further arrangement is proposed, comprising at least a gripping means and the described joint inner part. The gripping means is arranged on one end face of the joint inner part, wherein the gripping means has at least one gripping element which interacts with the contact area of the recess and forms a form-fitting connection effective in at least one of the circumferential directions. The gripping means can be arranged between a first clamping means and an end face of the joint inner part so that the joint inner part, when the joint inner part is clamped in a machining device by means of a second clamping means abutting the other end face of the joint inner part, can be aligned so that the trunnion axis of one trunnion is arranged coaxially with an axis of rotation of the machining device.

The gripping means is particularly advantageous already in the case when the trunnion axes do not extend at an inclination angle but parallel to the radial direction. In this way, a form-fitting connection between the gripping means and the joint inner part can already be achieved.

The gripping means is particularly advantageous when the trunnion axes extend at an inclination angle. It is precisely with this inclination of the trunnion axis(es) that mechanical machining of the trunnion surface in a machining device, e.g., by turning or grinding, is difficult to achieve. It is not possible to align the joint inner part using the known clamping means and the end faces because the trunnion axes are not parallel to the end faces. With the gripping means, the joint inner part or its end faces can be arranged at an angle to the machining device in such a way that the trunnion axis extends parallel and coaxially to an axis of rotation of the machining device.

In particular, the gripping means forms a point or line contact with the recess that acts in a form-fitting manner (at least) relative to the circumferential direction on the contact area. As a result of the point or line contact, a reproducible bearing contact of the gripping element on the contact area can be achieved.

When the gripping means is arranged on the joint inner part, the at least one gripping element is arranged in the radial direction outside of the recess and engages into the recess. In particular, the gripping means is designed in such a way that the trunnion surface can be machined by a tool (e.g., a turning tool or a grinding wheel) which is moved along a direction being perpendicular to the trunnion axis. In particular, the accessibility of the trunnion for a tool is to be provided beyond a plane which extends transversely to the trunnion axis and through the transition between the central body and the trunnion. This means, in particular, that the gripping means should not extend beyond this plane.

This arrangement of the gripping means is made possible in particular by the recesses, through which a form-fitting connection can be shifted from the outer circumferential surface of the central body along the radial direction into the central body.

In particular, the gripping means has a number of gripping elements corresponding to the number of recesses, with each gripping element engaging in one recess.

In particular, a method for machining a joint inner part in a machining device with the described arrangement is proposed. The machining device has at least two clamping means by which the arrangement can be clamped in the machining device and the joint inner part can be aligned so that a trunnion axis of one trunnion is arranged coaxially with an axis of rotation of the machining device. The method comprises at least the following steps:
a) arranging the joint inner part and the gripping means between the clamping means so that a trunnion axis of one trunnion is arranged coaxially with the axis of rotation of the machining device;
b) operating the machining device and rotating the joint inner part about the trunnion axis;
c) mechanically machining the trunnion with a tool.

The above (non-exhaustive) division of the method steps into a) to c) is primarily intended only for differentiation purposes and does not impose any sequence and/or dependency. The frequency of the method steps, e.g., during the setup and/or operation of the machining device, may also vary. It is also possible that method steps may overlap at least partially in terms of time. Method step c) is particularly preferred to take place during step b). In particular, steps a) to c) are carried out in the order listed, with steps a) and b) continuing to be carried out during step c).

In particular, the joint inner part has a trunnion whose trunnion axis extends at an inclination angle relative to the radial direction and is arranged in a plane formed by the rotation axis and the radial direction, wherein the absolute value of the inclination angle is greater than zero degrees. The rotation axis is arranged, at least during step c), at an angle to the radial direction by the absolute value of the inclination angle.

In particular, the clamping means are advanced during step a) in a direction extending transversely to the axis of rotation. The first clamping means thereby contacts the gripping means and the gripping means contacts one end face of the joint inner part. The second clamping means is advanced simultaneously in an opposite direction and contacts the other end face of the joint inner part.

As part of step b), the joint inner part is rotated about the trunnion axis of the one trunnion and about the axis of rotation.

In step c), the at least one tool is advanced and the trunnion is mechanically machined. In particular, the essentially cylindrical circumferential surface of the trunnion is mechanically machined.

In particular, at least one data processing system is provided, which has means that are suitably equipped, configured, or programmed to carry out the method or that carry out the method.

In particular, the processing device comprises a data processing system, e.g., a control unit, which has means for executing the steps of the method and/or has means that are suitably equipped, configured, or programmed to execute the steps of the method or that execute the method.

The means comprise, for example, a processor and a memory in which commands to be executed by the processor are stored, as well as data lines or transmission devices that enable the transmission of commands, measured values, data, or the like between the elements mentioned.

The “means” may in particular comprise one or more of the following components: control(s), microcontroller(s), data memory, data connection, display devices (such as a display), counter or timer, at least one additional sensor, a power source, etc.

A computer program is also proposed, comprising commands which, when executed by a computer, cause the computer to perform the described method or the steps of the described method.

A computer-readable storage medium is also proposed, comprising commands which, when executed by a computer, cause the computer to execute the described method or the steps of the described method.

The embodiments of the method are particularly transferable to the arrangement, the joint inner part, the data processing system, and/or the computer-implemented method (i.e., the computer program and the computer-readable storage medium) and vice versa.

As a precaution, it should be noted that the numerals used here (“first,” “second,” etc.) serve primarily (only) to distinguish between several similar objects, sizes, or processes, i.e., in particular, they do not necessarily specify any dependency and/or sequence of these objects, sizes, or processes in relation to each other. If a dependency and/or sequence is required, this is explicitly stated here or is obvious to the skilled person when studying the specifically described design. Insofar as a component can occur multiple times (“at least one”), the description of one of these components may apply equally to all or some of the plurality of these components, but this is not mandatory.

The use of indefinite articles (“a”, “an”) in particular in the claims and the description reproducing them is to be understood as such and not as a numeral. Accordingly, the terms or components introduced in this way are to be understood as meaning that they are present at least once and, in particular, may also be present multiple times.

### BRIEF DESCRIPTION OF THE DRAWINGS

The disclosure and the technical environment are explained in more detail below with reference to the accompanying figures. It should be noted that the disclosure is not limited by the examples given. In particular, unless explicitly stated otherwise, it is also possible to extract partial aspects of the facts explained in the figures and combine them with other components and findings from the present description. In particular, it should be noted that the figures, and in particular the proportions shown, are only schematic. They show:

FIG. 1: a known deflected GI tripod joint in a view along the rotation axis of the joint outer part, partially in section;

FIG. 2: the GI tripod joint according to FIG. 1 in a side view in section;

FIG. 3: another GI tripod joint in a side view in section;

FIG. 4: the joint inner part according to FIG. 3 in a side view, in a state immediately after forging;

FIG. 5: the joint inner part according to FIG. 4 in a side view, in a state after mechanical processing;

FIG. 6: a machining device with a joint inner part according to FIG. 2, in a side view, in section;

FIG. 7: a machining device with a joint inner part of a joint according to FIG. 3, in a side view, in section;

FIG. 8: a machining device with an arrangement, in a side view in section;

FIG. 9: a first design variant of a joint inner part in a view along the rotation axis onto the first end face;

FIG. 10: a second design variant of a joint inner part in a view along the rotation axis;

FIG. 11: the joint inner part according to FIG. 10 in a side view;

FIG. 12: the joint inner part according to FIGS. 10 and 11, in a view along the rotation axis onto the second end face;

FIG. 13: the joint inner part according to FIG. 10 in a view from above with an indicated gripping means;

FIG. 14: the joint inner part according to FIGS. 10 to 12 with a gripping means according to a first design variant, in a perspective view;

FIG. 15: the joint inner part according to FIGS. 10 to 12 with a gripping means according to a second design variant, in a perspective view;

FIG. 16: the joint inner part according to FIG. 9 with a gripping means according to a third design variant, in a perspective view;

FIG. 17: the joint inner part according to FIGS. 9 and 16 with a gripping means according to a fourth design variant, in a side view;

FIG. 18: the joint inner part according to FIG. 9 with a gripping means according to a fifth design variant, in a side view;

FIG. 19: the gripping means according to FIG. 18 in a side view in section;

FIG. 20: the gripping device according to FIGS. 18 and 19 in a view along the rotation axis;

FIG. 21: the gripping device according to FIG. 19, in a view from above; and

FIG. 22: the gripping device according to FIGS. 18 to 21, in perspective view.

### DETAILED DESCRIPTION

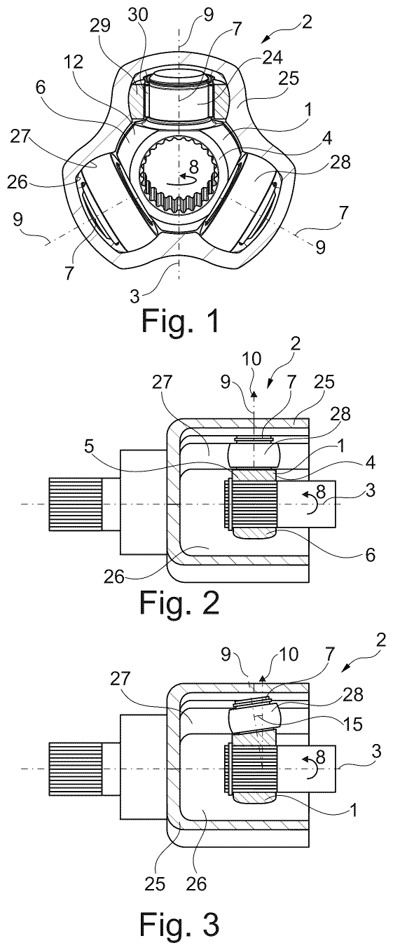

FIG. 1 shows a known deflected GI tripod joint 2 in a view along the first rotation axis 3, partially in section. FIG. 2 shows the GI tripod joint 2 according to FIG. 1 in a side view in section (in an extended position, i.e., with a deflection angle between the rotation axes 3 of the joint inner part 1 and the joint outer part 25 of zero degrees) in a side view in section. FIGS. 1 and 2 are described together below.

The tripod joint 2 comprises a joint outer part 25 with a rotation axis 3 and a joint inner part 1 with a rotation axis 3. The outer joint part 25 has a cavity 26 for the joint inner part 1 extending along the rotation axis 3, as well as three raceways 27 extending along the rotation axis 3 of the joint outer part 25 and distributed in a circumferential direction 8.

The joint inner part 1 has a rotation axis 3, a central body 6 extending along the rotation axis 3 between a first end face 4 and a second end face 5, and three trunnions 7, wherein the trunnions 7 are distributed along the circumferential direction 8 extending around the rotation axis 3 and each extend from the central body 6 along a trunnion axis 9 and exclusively along a radial direction 10. A roller body 28 is arranged on each trunnion 7, which contacts the trunnion 7 with an inner circumferential surface and the respective raceway 27 with an outer circumferential surface.

The tripod joint 2 is a so-called GI joint, in which the roller body 28 is formed by a ring body 29, which forms the outer circumferential surface, which is mounted directly on the trunnion 7 via rolling elements 30, which form the inner circumferential surface.

The outer circumferential surface extends coaxially to a roller body axis, whereby the roller body axis and the respective trunnion axis 9, which are arranged coaxially in FIGS. 1 and 2, can be tilted relative to each other by an angle of at most three degrees. The trunnion 7 or its circumferential surface 24, against which the roller body 28 rests, is circular cylindrical or (slightly) oval cylindrical.

In a GI joint 2, the roller body 28 is pivoted by the trunnion 7 or by the joint inner part 1 relative to the raceways 27 or the joint outer part 25.

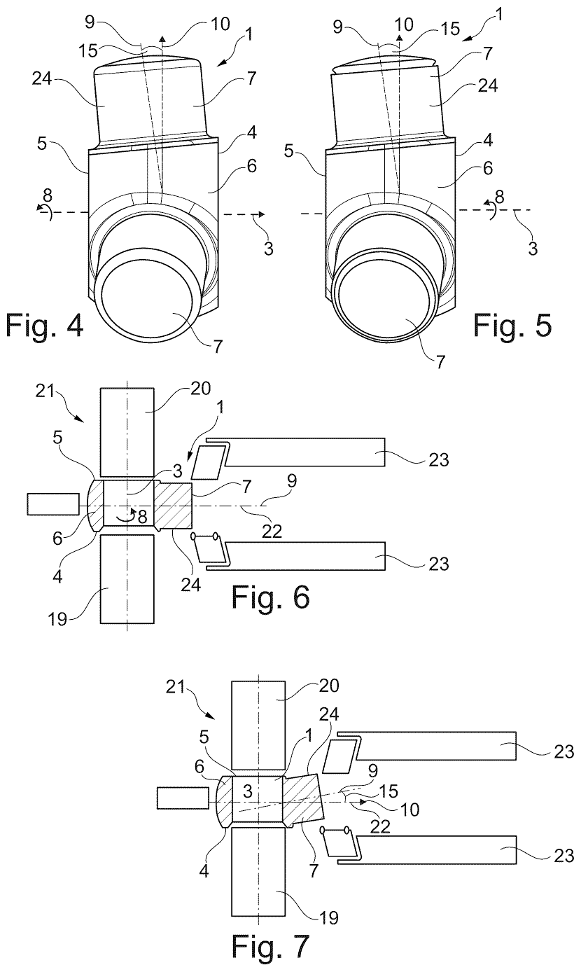

FIG. 3 shows another GI tripod joint 2 in a side view in section. FIG. 4 shows the joint inner part 1 of the joint 2 according to FIG. 3 in a side view, in a state immediately after forging. FIG. 5 shows the joint inner part 1 according to FIG. 4 in a side view, in a state after mechanical processing. FIGS. 3 to 5 are described together below. Reference is made to the explanations for FIGS. 1 and 2.

In contrast to the tripod joint 2 according to FIGS. 1 and 2, the joint inner part 1 has trunnions 7 whose trunnion axis 9 is inclined at an inclination angle 15 relative to the radial direction 10 and runs in a plane formed by the rotation axis 3 and the radial direction 10. The inclination angle 15 is approximately five degrees. All trunnion axes 9 of the joint inner part 1 are inclined at the same inclination angle 15 relative to the radial direction 10.

The inclination angle 15 is determined between the trunnion axis 9 and the radial direction 10, which extends perpendicular to the rotation axis 3 of the joint inner part 1.

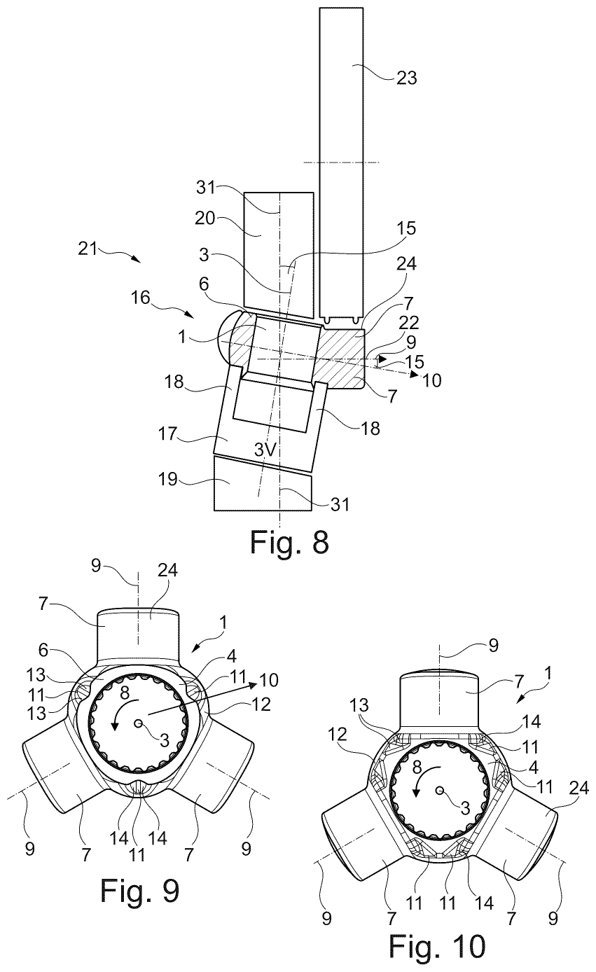

FIG. 6 shows a machining device 21 with a joint inner part 1 of a joint 2 according to FIG. 2, in a side view, in section. FIG. 7 shows a machining device 21 with a joint inner part 1 of a joint 2 according to FIG. 3, in a side view, in section. FIG. 8 shows a machining device 21 with an arrangement 16, in a side view in section. FIGS. 6 to 8 are described together below. Reference is made to the explanations relating to FIGS. 1 to 5.

Such joint inner parts 1 are usually manufactured by forging. After forging, mechanical machining is usually carried out. The cylindrical peripheral surfaces 24 of the trunnions 7 are mechanically machined, in FIGS. 6 and 7 by a tool 23 designed as a turning tool or by several tools 23 designed as turning tools.

For mechanical machining, the joint inner part 1 is held in a machining device 21 by two clamping means 19, 20. These contact the end faces 4, 5 of the joint inner part 1 and form a force-fit connection relative to the circumferential direction 8. The clamping means 19, 20 are arranged coaxially with the rotation axis 3 of the joint inner part 1. The machining device 21 has an axis of rotation 22 which extends transversely to the clamping means 19, 20 and thus transversely to the rotation axis 3 of the joint inner part 1.

The joint inner part 1 with the trunnions 7 extending exclusively along the radial direction 10 is arranged between the clamping means 19, 20 in such a way that a trunnion axis 9 is arranged coaxially with the axis of rotation 22. By rotating the joint inner part 1 about the axis of rotation 22, the circumferential surface 24 of the respective trunnion 7 can be machined. The other trunnions 7 are machined in turn after the clamping means 19, 20 and thus the joint inner part 1 have been rotated (indexed) about its rotation axis 3.

In the case of a joint inner part 1 with trunnions 7 extending at an inclination angle 15 (see FIGS. 7 and 8), mechanical machining of the circumferential surface 24 of the trunnions in a machining device 21, e.g. by turning or grinding, is only possible with difficulty. Alignment of the joint inner part 1 via the known clamping means 19, 20 and the end faces 4, 5 is now not possible because the trunnion axes 9 do not run parallel to the end faces 4, 5 (see FIG. 7).

An arrangement 16 is advantageous for such joints 2 (see FIG. 8). The arrangement 16 comprises a gripping means 17 and the described joint inner part 1. The gripping means 17 is arranged on a first end face 4 of the joint inner part 1, wherein the gripping means 17 has several gripping elements 18 which interact with the contact areas 13 of the recesses 11 on the joint inner part 1 and form several form-fitting connections effective with regard to the circumferential direction 8. The gripping means 17 is arranged between the first clamping means 19 and the first end face 4 of the joint inner part 1, so that when the joint inner part 1 is clamped in the machining device 21 by means of a second clamping means 20 abutting the second end face 5 of the joint inner part 1, it can be aligned so that the trunnion axis 9 of one trunnion 7 is arranged coaxially with the axis of rotation 22 of the machining device 21 (see FIG. 8).

When the gripping means 17 is arranged on the joint inner part 1, the gripping elements 18 are arranged outside of the recesses 11 in the radial direction 10 and engage into the recesses 11. The gripping means 17 is designed in such a way that the circumferential surface 24 of the trunnions 7 can be machined by a tool 23 (in FIG. 8, a grinding wheel) fed in a direction extending perpendicular to the trunnion axis 9. The accessibility of the trunnion 7 for a tool 23 is to be provided beyond a plane which extends transversely to the trunnion axis 9 and through the transition between the central body 6 and the trunnion 7.

The other trunnions 7 are machined after the clamping means 19, 20 and thus the joint inner part 1 have been rotated (indexed) about the (index) axis 31 of the clamping means 19, 20.

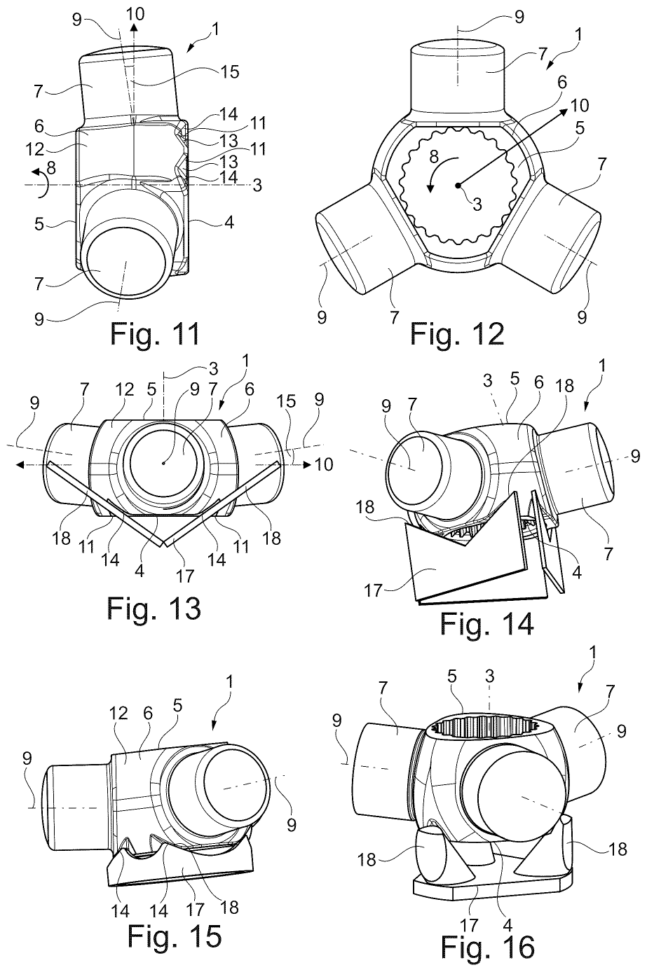

FIG. 9 shows a first design variant of a joint inner part 1 in a view along the rotation axis 3 onto the first end face 4. FIG. 10 shows a second design variant of a joint inner part 1 in a view along the rotation axis 3. FIG. 11 shows the joint inner part 1 according to FIG. 10 in a side view. FIG. 12 shows the joint inner part 1 according to FIGS. 10 and 11 in a view along the rotation axis 3 onto the second end face 5. FIG. 13 shows the joint inner part 1 according to FIG. 10 in a view from above with an indicated gripping means 17. FIG. 14 shows the joint inner part 1 according to FIGS. 10 to 12 with a gripping means 17 according to a first design variant, in a perspective view. FIG. 15 shows the joint inner part 1 according to FIGS. 10 to 12 with a gripping means 17 according to a second design variant, in a perspective view. FIG. 16 shows the joint inner part 1 according to FIG. 9 with a gripping means 17 according to a third design variant, in a perspective view. FIGS. 9 to 17 are described together below. Reference is made to the explanations relating to FIGS. 1 to 8.

The joint inner part 1 has a rotation axis 3, a central body 6 extending along the rotation axis 3 between a first end face 4 and a second end face 5, and three trunnions 7, wherein the trunnions 7 are distributed along a circumferential direction 8 extending around the rotation axis 3 and each extend from the central body 6 along a trunnion axis 9 and at least along a radial direction 10. The radial direction 10 extends perpendicular to the rotation axis 3 and to the circumferential direction 8. Only on the first end face 4 of the central body 6 are recesses 11 (three in FIG. 9, six in FIG. 10) arranged, which extend from the first end face 4 in a direction to an outer circumferential surface 12 of the central body 6. The recesses 11 have a contact area 13 that forms a bearing area 14 effective with regard to the circumferential direction 8.

Compared to the usual shape of the central body 6 (see FIGS. 1, 4, 5), the recess 11 forms a local depression into which a gripping element 18 of a gripping means 17 can engage. This means that the form-fitting connection is not formed on the outer circumferential surface 12 of the central body 6, but is shifted into the central body 6. The gripping means 17 is arranged in a machining device 21 between one of the clamping means 19, 20 and the first end face 4, 5 of the joint inner part 1. The gripping means 17 has a number of gripping elements 18 corresponding to the recesses 11. Each gripping element 18 forms a form-fitting connection with one recess 11 with regard to the circumferential direction 8. This allows the joint inner part 1 to be clamped securely in the machining device 21.

The positive/form fitting connection acts in the case of each recess 11 according to FIG. 10 with regard to only one of the circumferential directions 8 (clockwise or counterclockwise). In the case of the recesses 11 according to FIG. 9, the positive/ form fitting connection acts with regard to both circumferential directions 8.

The recesses 11 have contact areas 13 which form a bearing area 14 for the gripping element 18 that acts in the circumferential direction 8, i.e. the gripping element 18 contacts the contact area(s) 13 and rests on the bearing area 14 (FIGS. 10, 11, 13, 14, 15) or the bearing areas 14 (FIGS. 9, 13, 16).

According to FIG. 10, several pairs of recesses 11 are provided. Three (identical) recesses 11 are provided twice. Two different recesses 11 form a pair, so that the pair forms positive/form fitting connections in both circumferential directions 8.

The recesses are only arranged on the first end face 4 and are evenly distributed along the circumferential direction 8 (see FIG. 9) or evenly distributed in pairs (see FIG. 10).

Each recess 11 is arranged along the circumferential direction 8 between two trunnion axes 7 that are arranged adjacent to each other along the circumferential direction 8. The recesses 11 are arranged in such a way that none of the recesses 11 is aligned with a trunnion axis 9 or extends to the trunnion axis 9 or beyond the trunnion axis 9 when the joint inner part 1 is viewed along the rotation axis 3 (see, for example, FIGS. 9 and 10).

The recesses 11 are designed such that they extend from the first end face 4 along the rotation axis 3 to such an extent that they intersect with the trunnion 7 in a view of the joint inner part 1 from the side, i.e., in a view transverse to the rotation axis 3 of the joint inner part 1 (see, for example, FIGS. 11 and 13). In this view the projection of the trunnion 7 and the recess 11 onto the rotation axis 3 is considered/looked at (the projection is made in a direction perpendicular to the rotation axis 3).

The contact area 13, which interacts with the gripping element 18 to form the positive/form fitting connection, is convex in shape. The contact area 13 is convexly curved, in particular spherical.

FIG. 13 shows gripping elements 18 that bear against the bearing areas 14 of a pair of recesses 11. Bearing areas 14 are formed on only one side of each recess 11, creating a positive/form fitting connection. The areas arranged on the other side of each recess are contact areas 13, which do not serve as bearing areas for the gripping elements 18. A gripping means 17 with this function is shown in FIG. 14. FIGS. 15 and 16 show further design variants of gripping means 17.

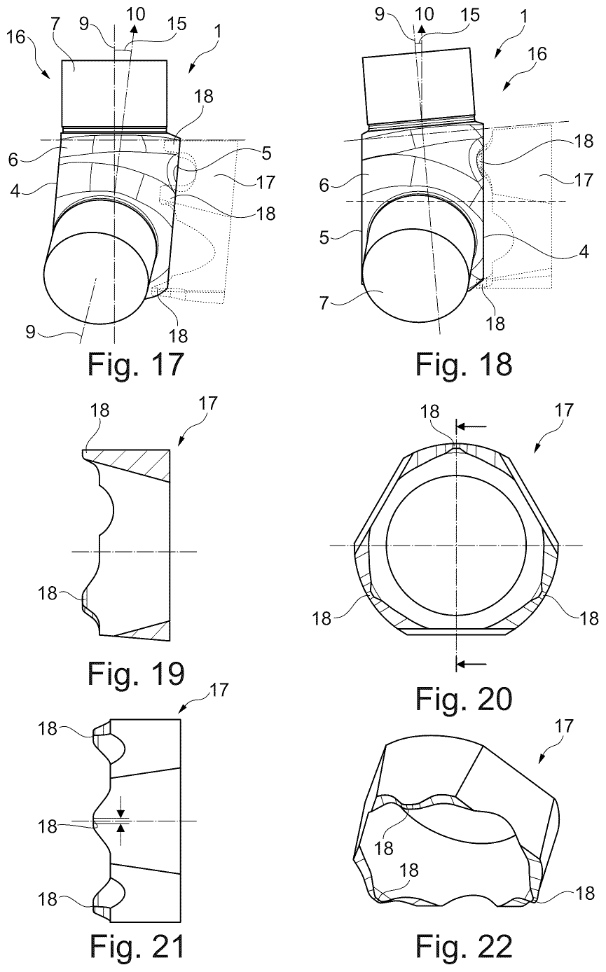

FIG. 17 shows the joint inner part 1 according to FIGS. 9 and 16 with a gripping means 17 according to a fourth design variant, in a side view. FIG. 18 shows the joint inner part 1 according to FIG. 9 with a gripping means 17 according to a fifth design variant, in a side view. FIGS. 17 and 18 are described together below. Reference is made to the explanations for FIGS. 1 to 16.

The gripping means 17 according to FIG. 17 has six gripping elements 18, while the gripping means 17 according to FIG. 18 has three gripping elements 18.

In FIG. 17, the gripping device 17 contacts the central body 6 next to the recesses 11. This does not provide secure support for the joint inner part 1.

When the gripping means 17 is arranged on the joint inner part 1, the gripping elements 18 are arranged in the radial direction 10 outside of the respective recess 11 and engage into the recess 11 (FIG. 18). The gripping means 17 is designed in such a way that the peripheral surface 24 can be machined by a tool 23 (e.g., a turning tool or a grinding wheel) which is fed in a direction extending perpendicular to the trunnion axis 9. The accessibility of the trunnion 7 for a tool 23 can be provided beyond a plane that extends transversely to the trunnion axis 9 and through the transition between the central body 6 and the trunnion 7 (see dotted line above the gripping means in FIGS. 17 and 18).

This arrangement of the gripping means 17 is made possible by the recesses 11, through which a form-fitting connection can be shifted from the outer circumferential surface 12 of the central body 6 along the radial direction 10 into the central body 6.

FIG. 19 shows the gripping means 17 according to FIG. 18 in a side view in section. FIG. 20 shows the gripping means 17 according to FIGS. 18 and 19 in a view along the rotation axis 3. FIG. 21 shows the gripping means 17 according to FIG. 19 in a view from above. FIG. 22 shows the gripping device 17 according to FIGS. 18 to 21 in a perspective view. FIGS. 19 to 22 are described together below. Reference is made to the explanations in FIGS. 1 to 18.

The gripping device 17 is designed for a joint inner part 1 according to FIG. 9. It has three gripping elements 18 which are intended to interact with the three recesses 11. The clamping device 19 is arranged on the flat rear wall. This rear wall can also be inclined so that the inclination angle 15 of the trunnions 7 is compensated.

1. A joint inner part of a multipod joint, wherein the joint inner part has a rotation axis, a central body extending along the rotation axis between a first end face and a second end face, and at least two trunnions, wherein the trunnions are distributed along a circumferential direction extending around the axis of rotation, and each extending from the central body along a trunnion axis and at least along a radial direction, the radial direction extending perpendicular to the rotation axis and to the circumferential direction; wherein at least one recess is arranged on one end face of the central body, which recess extends from the end face to an outer circumferential surface of the central body, wherein the recess has a contact area which forms a bearing area effective relative to the circumferential direction.

2. The joint inner part according to claim 1, wherein at least one trunnion axis extends at an inclination angle relative to the radial direction and in a plane formed by the rotation axis and the radial direction, wherein the absolute value of the inclination angle is greater than zero degrees.

3. The joint inner part according to claim 2, wherein the at least one recess is arranged exclusively on the end face from which the trunnion axis, extending at the inclination angle, extends away.

4. The joint inner part according to claim 1, wherein at least three recesses are arranged on one end face and distributed along the circumferential direction.

5. The joint inner part according to claim 1, wherein a plurality of recesses are arranged on one end face and distributed along the circumferential direction, each recess being arranged along the circumferential direction between two trunnion axes arranged adjacent to each other along the circumferential direction.

6. The joint inner part according to claim 1, wherein the contact area is convex in shape.

7. An arrangement comprising at least a gripping means and a joint inner part according to claim 1, wherein the gripping means is arranged on an end face of the joint inner part, wherein the gripping means has at least one gripping element which interacts with the contact area of the recess and forms a form-fitting connection effective relative to at least the circumferential direction; wherein the gripping means can be arranged between a first clamping means and one end face of the joint inner part so that the joint inner part, when clamped in a machining device by a second clamping means arranged at the other end face of the joint inner part, can be aligned in such a way, that that the trunnion axis of one trunnion is arranged coaxially with an axis of rotation of the machining device.

8. The arrangement according to claim 7, wherein the gripping means forms a point or line contact with the recess that acts in a form-fitting manner with regard to the circumferential direction.

9. The arrangement according to claim 7, wherein the gripping means has a number of gripping elements corresponding to the number of recesses, each gripping element engaging in one recess respectively.

10. A method for machining an joint inner part in a machining device with an arrangement according to claim 7; wherein the machining device has at least two clamping means by means of which the arrangement can be clamped in the machining device and the joint inner part can be aligned so that a trunnion axis of one trunnion is arranged coaxially with an axis of rotation of the machining device; wherein the method comprises at least the following steps:
a) arranging the joint inner part and the gripping means between the clamping means so that the trunnion axis of the one trunnion is arranged coaxially with the axis of rotation of the machining device;
b) Operating the machining device and rotating the joint inner part about the trunnion axis;
c) Mechanically machining the trunnion with a tool.

11. The method according to claim 10, wherein the joint inner part has a trunnion whose trunnion axis extends at an inclination angle relative to the radial direction and in a plane formed by the rotation axis and the radial direction, the absolute value of the inclination angle being greater than zero angular degrees; wherein the axis of rotation, at least during step c), is inclined relative to the radial direction by the absolute value of the inclination angle.
